(19) United States
(12) Patent Application Publication
(10) Pub. No.: US 2023/0419125 A1
(43) Pub. Date: Dec. 28, 2023

(54) SYSTEM AND METHOD FOR CAPACITY PLANNING FOR DATA AGGREGATION USING SIMILARITY GRAPHS

(71) Applicant: Dell Products L.P., Round Rock, TX (US)

(72) Inventors: Ofir Ezrielev, Be'er Sheva (IL); Jehuda Shemer, Kfar Saba (IL)

(21) Appl. No.: 17/850,764

(22) Filed: Jun. 27, 2022

(51) Int. Cl. G06N 5/02

(52) U.S. Cl. CPC G06N 5/022

(57) ABSTRACT

Methods and systems for managing data aggregation in a distributed environment are disclosed. The data may be aggregated using twin inference models which may be used to reduce a quantity of data transmitted to aggregate the data. To obtain twin inference models, models may be trained which may consume computing resources. A computing resource cost for training the twin inference models may be estimated based on an estimated number of twin inferences models necessary to meet inference accuracy goals. A model training device that has an available quantity of computing resources sufficient to meet the computing resource cost may be obtained. The model training device may be used to train and distribute inference models for data aggregation purposes.

### FIELD

Embodiments disclosed herein relate generally to data collection. More particularly, embodiments disclosed herein relate to systems and methods to limit the transmission of data over a communication system during data collection.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a block diagram illustrating data flow in a system in accordance with an embodiment.

FIG. 3 shows a flow diagram illustrating a method of aggregating data in accordance with an embodiment.

FIGS. 4A-4E show block diagrams illustrating a system and/or a similarity graph generated by the system in accordance with an embodiment over time.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing data aggregation in a distributed environment. The data may be aggregated using twin inference models which may be used to reduce a quantity of data transmitted to aggregate the data.

To obtain twin inference models, models may be trained which may consume computing resources. To ensure that sufficient quantities of twin inference models may be obtained timely for data aggregation purposes, a computing resource cost for training the twin inference models may be estimated based on an estimated number of twin inferences models necessary to meet inference accuracy goals. The inference accuracy goals may be based on acceptable levels of error introduced into aggregated data through the use of inference in data aggregation which may include some amount of error. Once the computing resource cost is identified, a model training device that has an available quantity of computing resources sufficient to meet the computing resource cost may be obtained. The model training device may then be used to train and distribute inference models for data aggregation purposes.

By doing so, data may be aggregated timely with a desired level of accuracy and at reduced computing resource expenditure levels for transmission of data for data aggregation purposes. Consequently, a system in accordance with embodiments disclosed herein may have an increased quantity of computing resources available for other purposes. Therefore, embodiments disclosed herein may address the technical problem of limited computing resources availability and may provide an improved system and devices that have increased availability of computing resources through reduction in computing resource expenditures for data aggregation.

In an embodiment, a method for managing data collection in a distributed environment where data is aggregated in a data aggregator of the distributed environment and the data is collected from data collectors operably connected to the data aggregator via a communication system is provided. The method may include obtaining an error limit for the data aggregated in the data aggregator; obtaining a similarity graph for the data collectors; identifying, using the similarity graph, a quantity of computing resources to train a quantity of twin inference models, the quantity of twin inference models being based on the error limit; obtaining a model training device based on the quantity of computing resources; initiating aggregation of the data collected by the data collectors using the model training device; obtaining the data aggregated in the data aggregator using the quantity of the twin inference models trained by the model training device.

Initiating aggregation of the data collected by the data collectors using the model training device may include training the quantity of the twin inference models based on the error limit; and deploying the quantity of the twin inference models based on groupings of the data collectors based on the similarity graph.

Identifying the quantity of computing resources may include identifying an edge value threshold based on the error limit for the data; grouping nodes of the similarity graph into groupings based on the edge value threshold; and calculating the quantity of computing resources based on a cardinality of the groupings and a per twin inference model computing resources training cost.

The similarity graph may include nodes, each node of the nodes corresponding to one of the data collectors; and edges, each of the edges associating a pairs of nodes, the respective edge indicating a similarity of data collected by the associated pair of the nodes.

The data collectors that are members of each grouping may receive a same twin inference model of the quantity of the twin inference models, and data collectors that are members of different groups of the groups receive different twin inference models of the quantity of the twin inference models.

Obtaining the data aggregated in the data aggregator may include obtaining, from a first data collector of the data collectors that is a member of a group of the groupings, first reduced size data based on a portion of data collected by the first data collector; obtaining, from a second data collector of the data collectors that is a member of the group of the groupings, second reduced size data based on a portion of data collected by the first data collector; reconstructing the portion of the data collected by the first data collector using a first inference obtained from a first twin inference model of the quantity of twin inference models; and reconstructing the portion of the data collected by the second data collector using a second inference obtained from the first twin inference model of the quantity of twin inference models.

Obtaining the data aggregated in the data aggregator may also include obtaining, from a third data collector of the data collectors that is a member of a second group of the groupings, third reduced size data based on a portion of data collected by the third data collector; and reconstructing the portion of the data collected by the third data collector using a third inference obtained from a second twin inference model of the quantity of twin inference models.

The reconstructed portion of the data collected by the first data collector may include a quantity of error that is within the error limit (e.g., an acceptable error level).

The model training device may be obtained by selecting the model training device from a plurality of model training device, the selected model training device having access to a quantity of computing resources that exceeds the identified quantity of computing resources.

The model training device may be obtained by allocating computing resources to the model training device until the model training device has access to a quantity of computing resources that exceeds the identified quantity of computing resources.

The model training device may be obtained by transferring workloads hosted by the model training device to other devices until a quantity of free computing resources of the model training device exceeds the identified quantity of computing resources.

Obtaining a model training device based on the quantity of computing resources may include increasing the error limit; identifying, using the similarity graph, a second quantity of computing resources to train a second quantity of twin inference models, the second quantity of twin inference models being based on the increased error limit; and obtaining a model training device based on the second quantity of computing resources.

A non-transitory media may include instructions that when executed by a processor cause the method to be performed.

A data processing system may include the non-transitory media and a processor, and may perform the method when the computer instructions are executed by the processor.

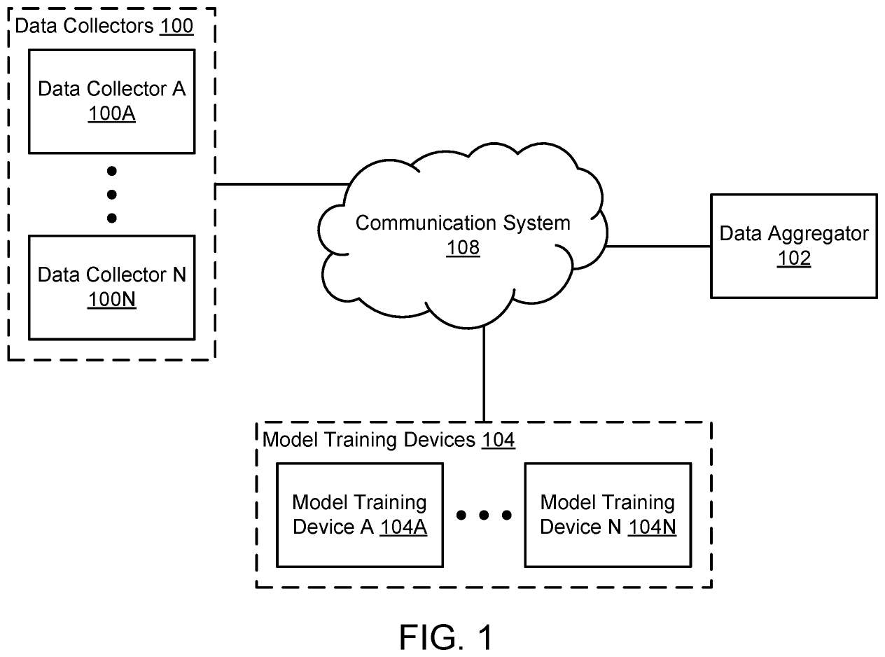

Turning to FIG. 1, a block diagram illustrating a system in accordance with an embodiment is shown. The system shown in FIG. 1 may provide computer-implemented services that may utilize data aggregated from various sources throughout a distributed environment.

The system may include data aggregator 102. Data aggregator 102 may provide all, or a portion, of the computer-implemented services. For example, data aggregator 102 may provide computer-implemented services to users of data aggregator 102 and/or other computing devices operably connected to data aggregator 102. The computer-implemented services may include any type and quantity of services which may utilize, at least in part, data aggregated from a variety of sources (e.g., data collectors 100) within a distributed environment.

For example, data aggregator 102 may be used as part of a control system in which data that may be obtained by data collectors 100 is used to make control decisions. Data such as temperatures, pressures, etc. may be collected by data collectors 100 and aggregated by data aggregator 102. Data aggregator 102 may make control decisions for systems using the aggregated data. In an industrial environment, for example, data aggregator 102 may decide when to open and/or close valves using the aggregated data. Data aggregator 102 may be utilized in other types of environments without departing from embodiments disclosed herein.

To facilitate data collection, the system may include one or more data collectors 100. Data collectors 100 may include any number of data collectors (e.g., 100A-100N). For example, data collectors 100 may include one data collector (e.g., 100A) or multiple data collectors (e.g., 100A-100N) that may independently and/or cooperatively provide data collection services.

For example, all, or a portion, of data collectors 100 may provide data collection services to users and/or other computing devices operably connected to data collectors 100. The data collection services may include any type and quantity of services including, for example, temperature data collection, pH data collection, humidity data collection, etc. Different systems may provide similar and/or different data collection services.

To aggregate data from data collectors 100, data aggregator 102 and/or data collectors 100 may host inference models (also referred to as “twin inference models”) to facilitate a reduction in the quantity of data transmitted over communication system 108 during data collection. For example, the inference models may be used to allow data aggregator 102 to predict data that will likely be obtained by data collectors 100, thereby entirely or partially eliminating the need for data collectors 100 to provide data aggregator 102 with copies of all obtained data for data aggregator 102 to have access to such data.

Data collectors 100 may be part of the same distributed environment while being positioned in locations with different ambient conditions (and proximity to different areas of the environment). In order to facilitate data collection in these disparate ambient environments, data aggregator 102 may host multiple inference models, as noted above, to cooperatively reduce communications for aggregating data. The inference models may correspond to different data collectors or group of data collectors (e.g., where all members of the group host a same copy of the twin inference model).

Hosting and operating large quantities of inference models may have undesirable effects on data aggregator 102 and/or communication system 108. For example, hosting and operating multiple inference models may require increased computational overhead for data aggregator 102. For example, operating a unique inference model for each of data collectors 100 may result in increased network transmissions during training and re-training of models (e.g., generation, distribution, and updating), which may increase network bandwidth and power consumption throughout the distributed environment.

To reduce the quantity of inference models utilized for inference model use (e.g., generation, distribution, updating, and/or operation), some of data collectors 100 may be grouped into groups. As noted above, all of the data collectors of the group may use the same inference model. However, doing so may result in a reduced level of inference accuracy for all of the members of the group if the members of the group collect data that may be characteristically different from data collected by other data collectors.

To manage the level of inference error introduced by shared inference models among various groups of data collectors, the data collectors may be grouped based on the level of similarity between the data collected by the respective data collectors and/or likelihood of shared inference models producing accurate inferences for data collected by the data collectors of each group. By grouping the data collectors based on the similarity levels of the data collected and/or likely inference accuracy, the shared inference models may have improved inference accuracy with respect to data collected by each of the data collectors in the group.

When operating, the system of FIG. 1 may aggregate data from data collectors 100 in data aggregator 102. When doing so, inferences of varying levels of accuracy may be used to reduce the quantity of data transmitted from data collectors 100 to data aggregator 102. However, doing so may introduce a level of error into the aggregated data due to the inaccuracy level of inferences used to reduce the quantity of data transmitted as part of the aggregation process. For example, a data collector may elect not to provide a copy of collected data to data aggregator 102 if a locally generated inference for the collected data is within a threshold from the collected data. In response to not receiving a copy of the data collected by the data collector, data aggregator 102 may store a locally generated copy of the same inference used by the data collector as a copy of the data collected by the data collector in the aggregated data. Consequently, a level of difference (e.g., accuracy) between the aggregated data and the data collected by the data collector may be introduced through this process.

In general, embodiments disclosed herein may provide methods, systems, and/or devices for managing inference model use in a distributed environment. To manage inference model use in the system, a system in accordance with an embodiment may manage inference models in a manner that ensure aggregated data meets requirements such as, for example, an accuracy level with respect to representing data collected by data collectors. The accuracy level (and/or other requirements) may be identified via any method such as, for example, querying downstream consumers of the aggregated data to identify threshold levels of error that may introduce undesired operation in the downstream consumers of the data. The requirements may be identified via other methods without departing from embodiments disclosed herein.

Once identified, the requirements for the aggregated data may be used to identify a model training device capable of training inference models to meet the requirements. To do so, the system of FIG. 1 may (i) identify a quantity of inference models (which may need to be obtained within time limits) that are needed to meet the aggregated data requirements, (ii) identify a quantity of computing resources for training the quantity of inference models (as needed for data aggregation), and (iii) obtain a model training device for training inference models for the system. By doing so, a system in accordance with an embodiment may improve its likelihood of aggregating data in a manner that meets requirements such as accuracy while also reducing computing resource use for aggregating the data.

Further, the aforementioned process may be used revise levels of acceptable error in aggregated data taking into account cost. For example, by ascertaining a level of resources necessary to achieve data aggregation with a given level of error, a system may be planned by exploring how decreased or increased levels of error in aggregated data impact the quantity of available resources for model training.

To identify the quantity of inference models, the system may generate and utilize a similarity graph. The similarity graph may be used to group the data collectors from which data will be collected. The data collectors may be grouped so that the members of the groups all (typically) collect data within a predetermined level of similarity, which may be based on the aggregated data requirements. By doing so, when a twin inference model is used with respect to the group, the error introduced by the twin inference model use may be likely to be within the aggregated data requirements.

To identify the quantity of computing resources for training the quantity of inference models, the number of groups of data collectors and a computing resource estimate for training inference models for each group of the number of groups may be used to estimate the aggregate computing resource cost for training inference models. The estimated aggregate computing resource cost for training inference models may be used in conjunction with, for example, an inference model training schedule to identify a per unit time rate of aggregate computing resource cost for training inference models.

To obtain the model training device, the per unit time rate of aggregate computing resource cost for training inference models (and/or aggregate computing resource cost estimate for training the inference models) may be used to select a model training device, allocate computing resources to the selected model training device, and/or reduce computing resource use by the selected model training device. By doing so, a model training device may be obtained that include a quantity of available computing resources such that it is able to train, deploy, and/or otherwise use inference models at a rate to meet the demands of the system of FIG. 1 for data aggregation purposes.

To provide the aforementioned functionality, the system of FIG. 1 may include any number of data collectors 100, any number of model training devices 104, data aggregator 102, data aggregator 102, and communication system 108. Data aggregator 102 may aggregate data from data collectors 100. Model training devices 104 may train and distribute inference models used by data collectors 100 and data aggregator 102. Data collectors 100 may collect data. While illustrated in FIG. 1 as being separate devices, any of the functionalities of data collectors 100, data aggregator 102, and/or model training devices 104 may be performed a single device. For example, a single device may be collect data and train inference models. In another sample, a single device may both train inference models and aggregate data.

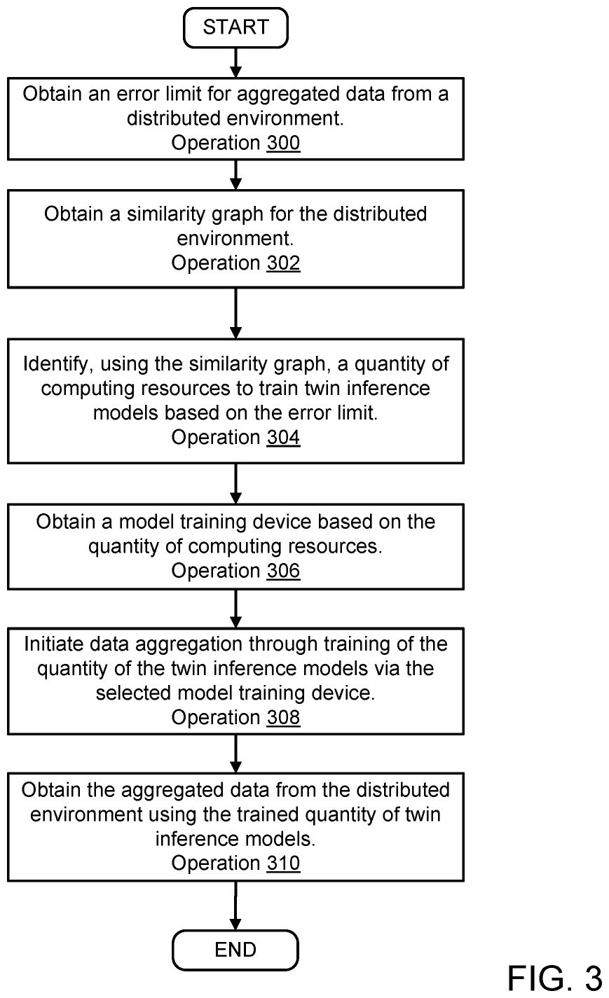

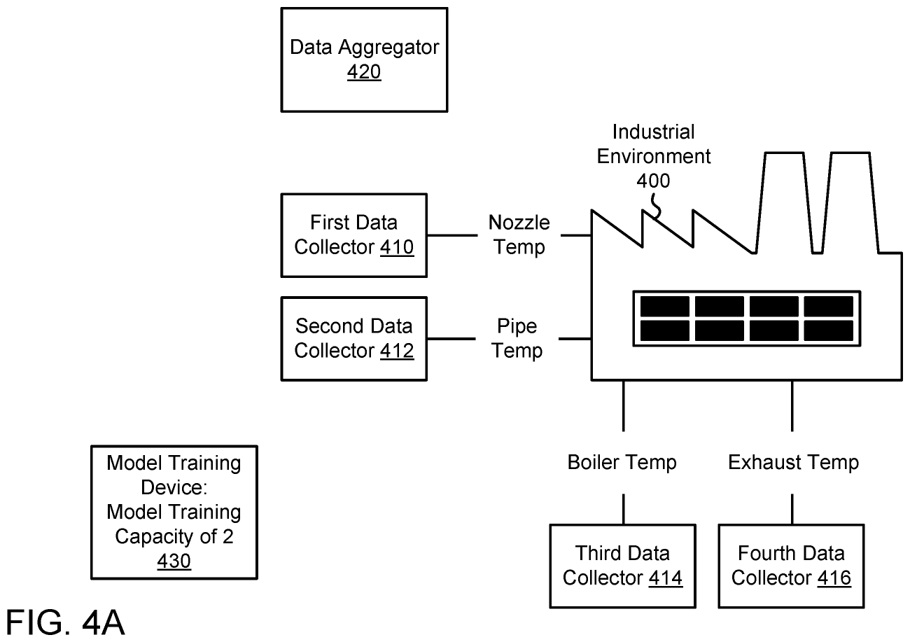

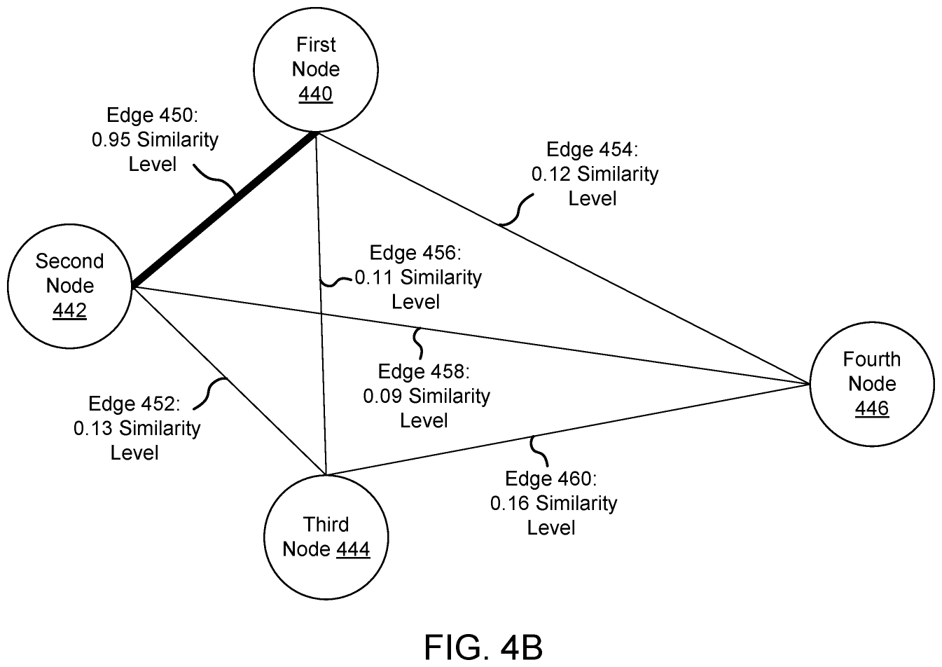

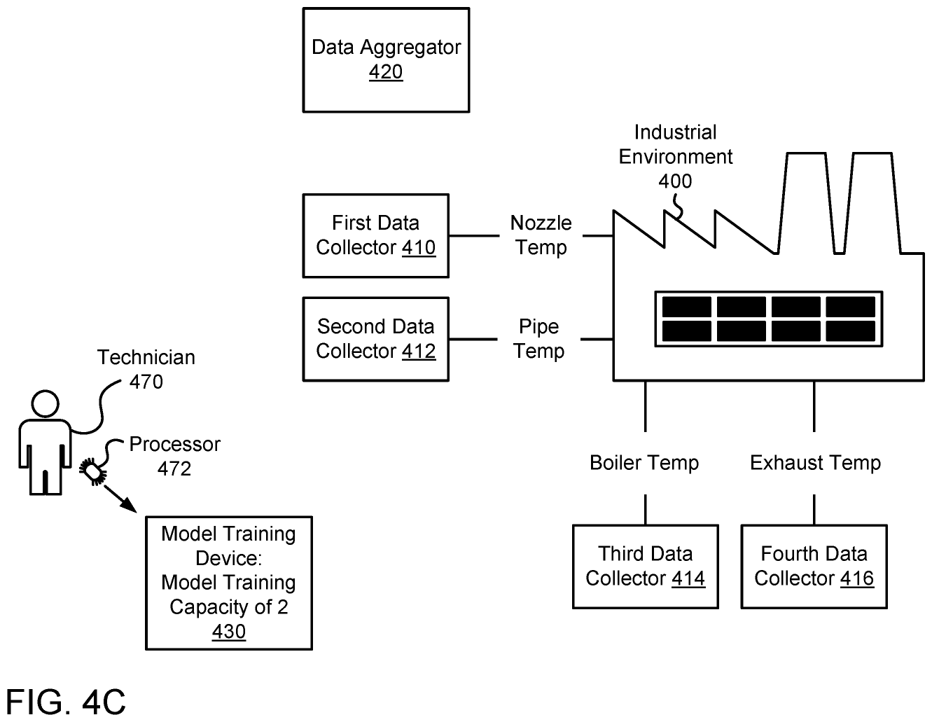

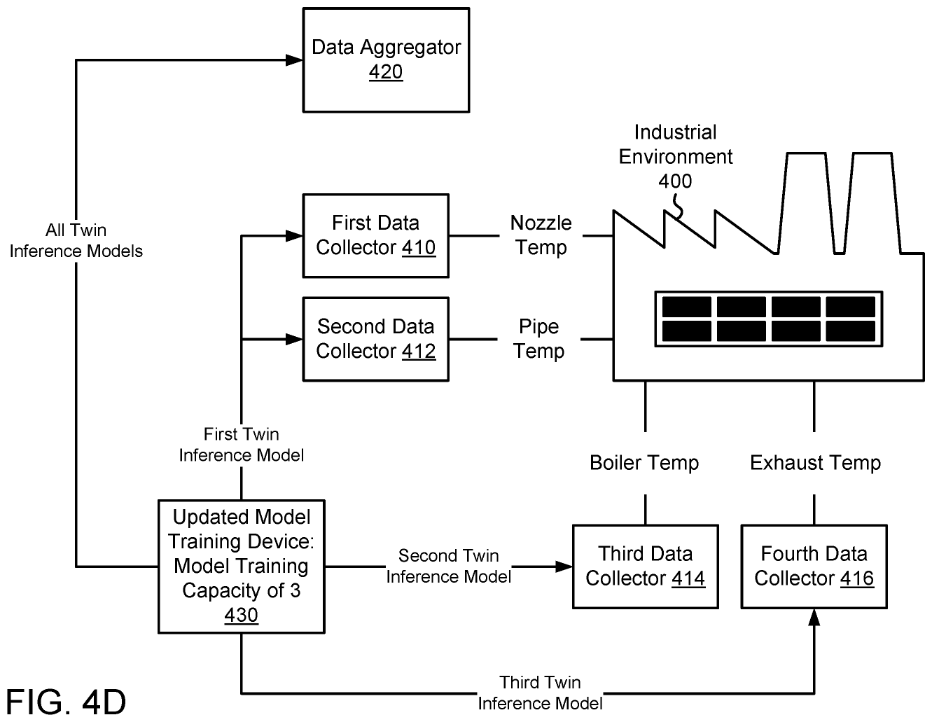

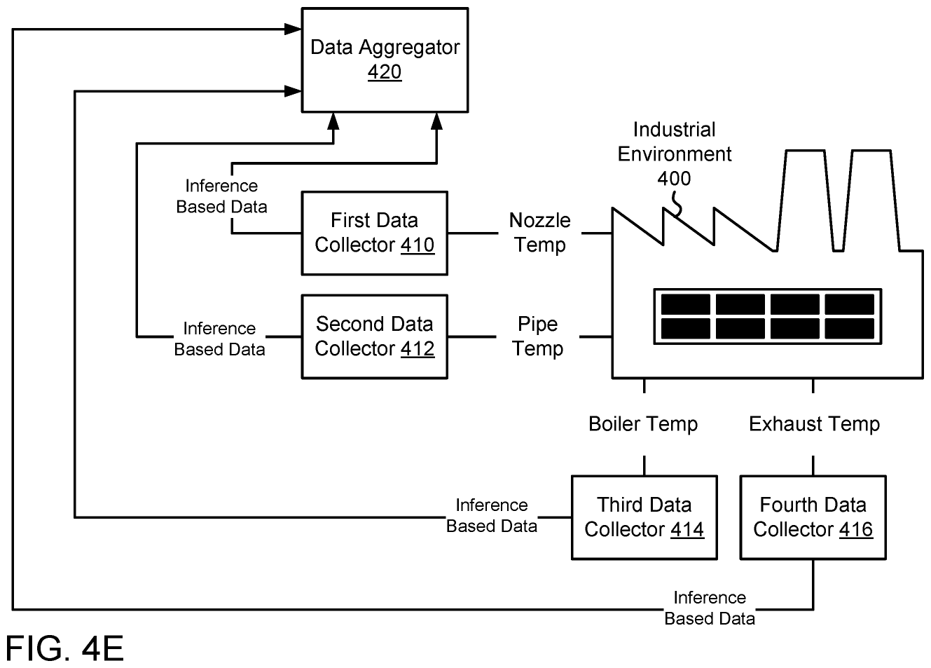

When performing its functionality, any of data collectors 100, data aggregator 102, and model training devices 104 may perform all, or a portion, of the methods and/or actions shown in FIGS. 3-4E.

As part of providing the above noted functionalities, trained inference models may be utilized to facilitate the reduction of data transmissions during data collection. In order to reduce data transmissions during data collection, inference models may be hosted and operated by data aggregator 102 and/or data collectors 100 and trained to predict data based on measurements performed by data collectors 100.

In a first example, data collectors 100 may obtain and transmit a data statistic (e.g., a reduced size data) to data aggregator 102. Data aggregator 102 may host an inference model trained to predict data based on measurements performed by data collectors 100 and may obtain a complementary data statistic based on the inferences. If the data statistic matches the complementary data statistic within some threshold, the inference model may be determined accurate and the inferences may be stored as aggregated data. By doing so, full data sets may not be obtained by data aggregator 102 from data collectors 100 and, therefore, data transmissions may be reduced across communication system 108.

In a second example, identical copies of a trained twin inference model may be hosted by data aggregator 102 and data collectors 100 and, therefore, may generate identical inferences. Data collectors 100 may reduce network transmissions by generating a difference (e.g., also referred to as reduced size data) based on: (i) data based on measurements performed by the data collectors and (ii) inferences generated by the copy of the twin inference model hosted by the data collectors. Data aggregator 102 may obtain the difference from data collectors 100 and may reconstruct data based on: (i) the difference and (ii) inferences generated by the copy of the twin inference model hosted by data aggregator 102. Consequently, full data sets (e.g., aggregated data from some number of data collectors) may not be transmitted over communication system 108 and network bandwidth consumption may be reduced while introducing some error into the full data sets. Inference models may be utilized to facilitate the reduction of data transmissions during data collection via other methods without departing from embodiments disclosed herein.

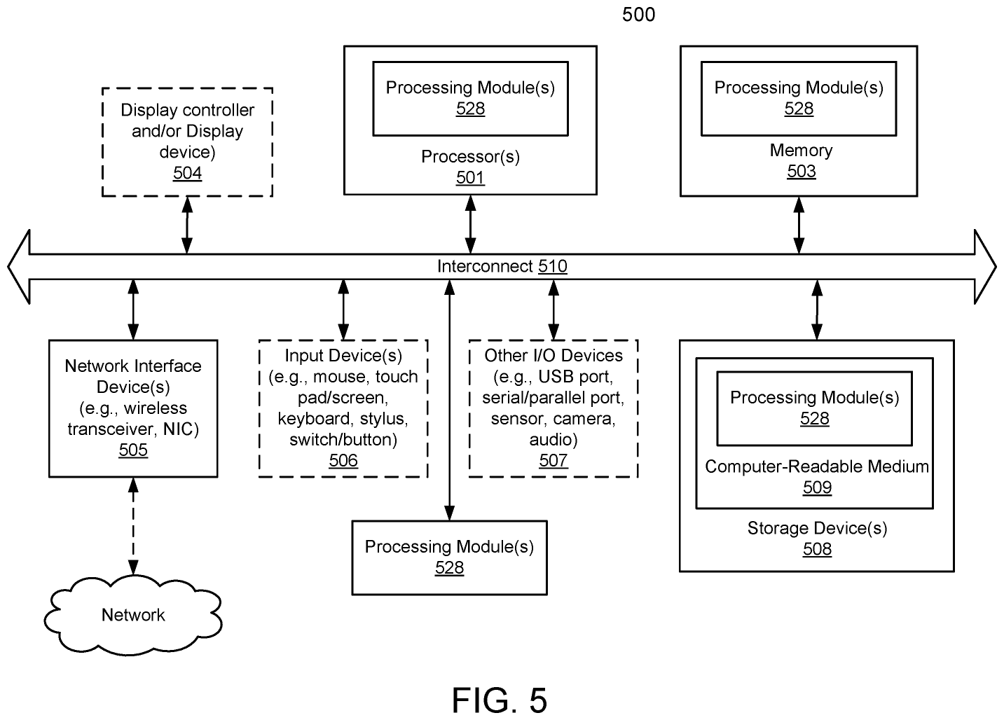

Data collectors 100, model training devices 104, and/or data aggregator 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

In an embodiment, one or more of data collectors 100 are implemented using an internet of things (IoT) device, which may include a computing device. The IoT device may operate in accordance with a communication model and/or management model known to the data aggregator 102, other data collectors, and/or other devices.

Any of the components illustrated in FIG. 1 may be operably connected to each other (and/or components not illustrated) with a communication system 108. In an embodiment, communication system 108 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

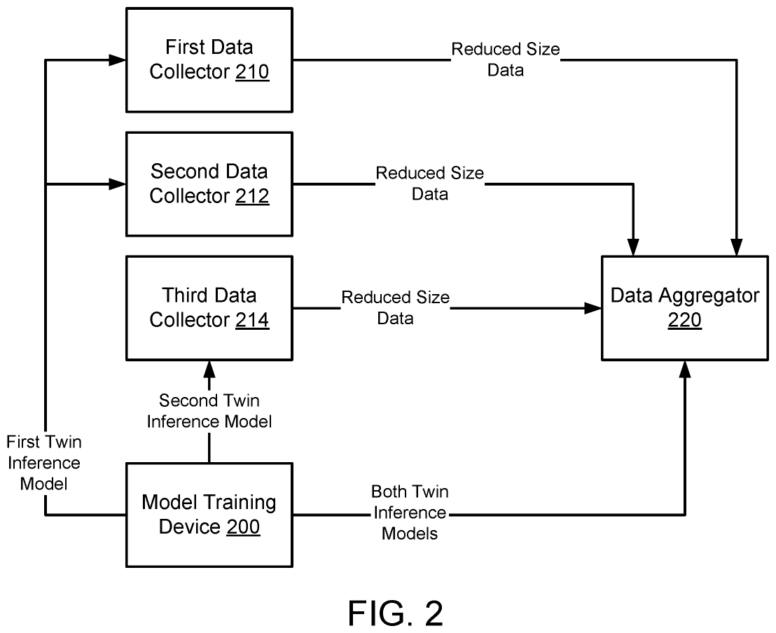

As discussed above, the system of FIG. 1 may aggregate data using twin inference models. Turning to FIG. 2, a diagram illustrating data flow in a data aggregation process in a system similar to that of FIG. 1 in accordance with an embodiment is shown. As seen in FIG. 2, the system includes devices (e.g., three data collectors 210, 212, 214 and data aggregator 220) that utilize twin inference models to reduce the quantity of data transmitted as part of the data aggregation process.

For example, as seen in FIG. 1, model training device 200 may generate and distribute twin inference models to both the data collectors and data aggregator 220. While all of the twin inference models are provided to data aggregator 220, difference twin inference models are provided to different groups of the data collectors. As noted above, the groups may be based on the similarity of data collected by the data collectors.

To group the data collectors, for example, information regarding the data collected by the data collectors may be analyzed. In this example, first data collector 210 and second data collector 212 may be collect data regarding a heating process while third data collector 214 may collect data regarding a material waste disposal process. The data collected by the first data collector 210 and second data collector 212 may be quite similar thereby allowing a single twin inference model to generate accurate inferences for the data collected by both data collectors 210, 212. In contrast, the data collected regarding the material waste disposal process may be characteristically different from the data collected regarding the heating process. Consequently, if a single twin inference model were used for all three data collectors, the resulting inference provided by the twin inference model may be of low accuracy (which may result in large amount of error being introduced into the aggregated data and/or copies of the actual collected data being transmitted to data aggregator 220 greatly increasing the consumption of computing resources (e.g. processing cycles, communication bandwidth) for data aggregation). Accordingly, the system of FIG. 2 may determine that only first data collector 210 and second data collector 212 are to be grouped, resulting in a first twin inference model being distributed to both first data collector 210 and second data collector 212 while a second twin inference model is distributed to third data collector 214. The first twin inference model may be trained based on the data likely to be collected by first data collector 210 and second data collector 212, while the second twin inference model may be trained based on the data likely to be collected by second data collector 212. Data aggregator 220 may use the twin inference models corresponding to the groups to reconstruct (or as a substitute for) the data collected by the respective groups.

To provide its function, model training device 200 may need to have available a quantity of computing resources to (i) obtain the inference models, (ii) reconfigure or obtain new inference models over time, and (iii) distribute the obtained or reconfigured inference models. To ensure that model training device 200 has sufficient available computing resources, model training device 200 may be selected and/or configured based on the number of inferences models that will be needed over time and the computing resource cost for doing so.

In an embodiment, one of more of first data collector 210, second data collector 212, third data collector 214, model training device 200, and data aggregator 220 are implemented using a hardware device including circuitry. The hardware device may be, for example, a digital signal processor, a field programmable gate array, or an application specific integrated circuit. The circuitry may be adapted to cause the hardware device to perform the functionality of first data collector 210, second data collector 212, third data collector 214, model training device 200, and/or data aggregator 220. First data collector 210, second data collector 212, third data collector 214, model training device 200, and/or data aggregator 220 may be implemented using other types of hardware devices without departing embodiment disclosed herein.

In one embodiment, one or more of first data collector 210, second data collector 212, third data collector 214, model training device 200, and data aggregator 220 are implemented using a processor adapted to execute computing code stored on a persistent storage that when executed by the processor performs the functionality of first data collector 210, second data collector 212, third data collector 214, model training device 200, and/or data aggregator 220 discussed throughout this application. The processor may be a hardware processor including circuitry such as, for example, a central processing unit, a processing core, or a microcontroller. The processor may be other types of hardware devices for processing information without departing embodiment disclosed herein.

Any of the twin inference models used by the systems of FIGS. 1 and 2 may be implemented with, for example, trained machine learning models. The machine learning models may be trained using training data (e.g., collected data over time) corresponding to groups of data collectors for which the trained machine learning models will provide inferences. The machine learning models may be implemented with, for example, neural networks. While described with respect to machine learning models and neural networks, the twin inference models may be implemented with other types of predictive entities without departing from embodiments disclosed herein.

While illustrated in FIG. 2 with a limited number of specific components, a system may include additional, fewer, and/or different components without departing from embodiments disclosed herein.

As discussed above, the components of FIG. 1 may perform various methods to manage data aggregation using twin inference models. FIG. 3 illustrates a method that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of aggregating data in accordance with an embodiment is shown.

At operation 300, an error limit (e.g., an acceptable level of error) for aggregated data from a distributed environment is obtained. The error limit may be obtained by (i) reading the error limit from storage, (ii) requesting and receiving the error limit from another entity, (iii) simulating the impact of various error limits for aggregated data on the operation of downstream consumers (e.g., applications that may provide computer implemented services using all, or a portion, of the aggregated data) of the aggregated data, and/or (iv) via other processes. The error limit may indicate a level of difference between a representation of data collected by data collectors (e.g., aggregated data hosted by a data aggregator) and the data collected by the data collectors that delineates an allowed level of difference from a disallowed level of difference. The error limit may be indicated, for example, granularly with respect to various portions of the aggregated data (e.g., difference limits for different portions of data) and/or on a macro level (e.g., a global difference limit).

At operation 302, a similarity graph for the distributed system is obtained using the error limit. The similarity graph may be obtained by (i) obtaining training data (usable to train twin inference models) for data collectors of the distributed system, (ii) generating nodes for the similarity graph, the nodes corresponding to respective data collectors, and/or (iii) adding edges between the nodes, the edges indicating a similarity level of the training data for the nodes corresponding to each edge. The similarity graph may be a representation of nodes (e.g., data collectors) and the relationships between the nodes. The similarity graph may display one node for each data collector throughout the distributed environment. While described with respect to a generation process, the similarity graph may be obtained receiving it from another entity or reading it from storage without departing from embodiments disclosed herein.

The edges between nodes may be represented by a similarity measure. The similarity measure may be a representation of the similarity between data (e.g., training data) obtained by data collectors associated with each node. Similarity measures may be displayed on the similarity graph as weighted edges between nodes. An edge with a larger weight may indicate similarity between the data associated with the nodes, while a smaller weight may indicate dissimilarity between the data associated with the nodes.

In an embodiment, the edges between nodes on the similarity graph are obtained by feeding training data into one or more similarity algorithms. The similarity algorithms may provide scores or other representations of the relative similarity of the training data. The similarity between the training data may be used as a basis for the edges between the nodes of the similarity graph.

At operation 304, a quantity of computing resources to train twin inference models based on the error limit is identified using the similarity graph. The quantity of computing resources may be identified by (i) grouping the nodes of the similarity graph into groups, and (ii) estimating a quantity of computing resources necessary to train a number of twin inference models corresponding the number of groups (e.g., one twin inference model for each group).

The nodes may be grouped based on the edges between the nodes. The nodes may be grouped so that the similarity level indicated by the edges between the nodes in each group indicate that inferences provided by a corresponding twin inference model will meet the error limit. For example, a similarity threshold may be established based on the error limit for the aggregated data. In an embodiment, all nodes having edges with a similarity level that exceeds the similarity threshold are added to corresponding groups to obtain the groups.

For example, consider a similarity graph with three nodes and edges between the nodes with similarity levels of 0.95, 0.3, and 0.1. If a similarity threshold of 0.9 is established based on an error limit of 10%, then the nodes connected by the edge having the similarity level of 0.95 may be added to a first group, and the remaining node may be added to a second group.

In an embodiment, nodes are added to groups (e.g., in order of most similar to least similar) which may progressively decrease the aggregate similarity level of the respective groups while the average (e.g., weighted or unweighted depending on number of members of each of the groups) similarity level of all of the groups exceeds the similarity threshold.

The quantity of computing resource may be estimated by multiplying the number of groups by a per twin inference model resource cost estimate for training a twin inference model. The per twin inference model resource cost estimate may be obtained by reading it from storage, receiving it from another device, through a processes of training an inference model for each group, and/or via other methods.

At operation 306, a model training device is obtained based on the quantity of computing resources. The model training device may be obtained by (i) selecting a model training device, (ii) assigning computing resources to the selected model training device so that the available computing resources of the selected model training device exceeds the quantity of computing resources to train the twin inference models, and/or (iii) decreasing use of computing resources of the selected model training device so that the available computing resources of the selected model training device exceeds the quantity of computing resources to train the twin inference models.

The model training device may be selected by discriminating it from other model training devices based on the quantity of computing resources to train the twin inference model. The selected model training device may have available computing resources that exceeds the quantity of computing resources to train the twin inference model, or may have fewer available computing resources (but may be the most available among the model training devices) than the quantity of computing resources to train the twin inference model. The model training device may also aggregate data and/or collected data.

The computing resource may be assigned to the selected model training device by, for example, adding computing resources (e.g., though addition of physical components such as processors, memory modules, storage devices, etc., or assignment of resources such as through hypervisor configuration (e.g., increasing a time slice duration) if the training device is a virtual machine) to the selected model training device. The computing resources may be added through, for example, scheduling a hardware upgrade for the model training device.

The use of the computing resources may be decreased by migrating workloads from the selected model training device to other devices.

In an embodiment, the model training device is obtained by (i) revising an error limit for the aggregated data, (ii) grouping the nodes of the similarity graph based on the revised error limit, (iii) identifying a revised quantity of computing resources to train the twin inference models, and (iv) performing a selection based on the revised quantity of computing resources. For example, if an initial quantity of computing resources is large or undesirable for various reasons (e.g., cost, practicality), the error limit may be increased so that a reduced number of twin inference models (and corresponding cost) may need to be trained. By doing so, a system may be planned by repeatedly revising the error limit to meet other goals such as cost or existing model training device availability limits. The revised error limit may, for example, be progressively increased until a quantity of computing resources for training inference models is reduced to a desired level (e.g., meets existing device capabilities, cost limits, etc.).

At operation 308, data aggregation is initiated. The data aggregation may be initiated through training of the quantity of the twin inference models via the selected model training device. For example, the model training device may begin training and distributing twin inference models to the groups of data collectors and the data aggregator. Because the model training device was previously selected, the model training device may have sufficient computing resources to train the quantity of twin inference models and distribute them to facilitate data aggregation. If the selected model training device did not have sufficient available computing resources, distribution of the twin inference models may be delayed which may negatively impact data aggregation through, for example, increased resource consumption for data aggregation or delayed data aggregation which may prevent downstream consumers from timely providing their services.

At operation 310, aggregated data from the distributed environment is obtained using the trained quantity of twin inference models. The aggregated data may be obtained, as discussed above, using inferences generated by the twin inference models. The inference may be used to reconstruct representations of data collected by data collectors and/or may be used as representations of the data collected by data collectors. The representations may be aggregated (together and/or with copies of transmitted data, which may be provided when inaccurate inferences are generated) to obtain the aggregated data.

While and following aggregation, computer implemented services may be provided using the aggregated data. For example, the aggregated data may be used to as part of the services such as, for example, to manage the operation of various systems, to provide information desired by users, to initiate other processes, and/or for other uses.

The method may end following operation 310.

Using the method illustrated in FIG. 3, embodiments disclosed herein may provide a method for planning and using data aggregation systems. By doing so, data may be timely aggregated with an acceptable level of error while reducing computing resource expenditures for aggregating the data.

Turning to FIGS. 4A-4E, these figures may illustrate a system similar to that of FIG. 1 and/or a similarity graphs in accordance with an embodiment. FIGS. 4A-4E may show actions performed by the system over time and/or a similarity graph upon with the changes may be based.

Now, consider a scenario in which a product is manufactured in industrial environment 400. The manufacturing process may include numerous processes such as heating liquids and exhausting heating from the system, in addition to other types of processes. The manufacturing process may be automated and use data aggregated from a number of data collectors 410, 412, 414, 416 and aggregated in data aggregator 420.

For example, first data collector 410 may collect data regarding the temperature of a nozzle used to spray a material as part of the manufacturing process. Second data collector 412 may collect data regarding the temperature of a pipe through which the material traverses to the nozzle. Third data collector 414 may collect data regarding the temperature of a lower portion of a boiler used to heat the material. In contrast to the temperatures of the nozzle and the pipe which may be similar to one another, the temperature of the boiler over time may be quite dissimilar because the material may be drawn from the boiler for other processes. Fourth data collector 416 may collect data regarding an exhaust temperature of an exhaust stream from a cooling process used to cool the product after it is manufactured. The exhaust temperature over time may be dissimilar to the nozzle temperature, the pipe temperature, and the boiler temperature.

To aggregate the data with data aggregator 420, the system may plan for the aggregation through selection of a model training device. In the system of FIG. 4A, model training device 430 is available to train inference models for use with the data collectors and data aggregator, but only includes available computing resources sufficient to train 2 inference models per cycle. Consequently, model training device 430 is unable to train an inference model for each of the collectors.

To plan for data aggregation, a similarity graph for the data collectors is generated. Turning to FIG. 4B, the similarity graph includes four nodes 440, 442, 444, 446 corresponding to the respective data collectors with first node 440 corresponding to first data collector 410, second node 442 corresponding to second data collector 412, third node 444 corresponding to third data collector 414, and fourth node 446 corresponding to fourth data collector 416.

As discussed above, only first and second data collectors collect data that is similar in character. Consequently, as seen in FIG. 4B, only edge 450 out of edges 450, 452, 454, 456, 458, and 460 indicate a high similarity level (which may be calculated using similarity metrics such as Person's correlation, Spearman's correlation, Kendall's Tau, Cosine similarity, Jaccard similarity, etc.; with distance metrics such as Euclidean distance or Manhattan distance; and/or similarity calculated using neural networks such as deep similarity). In this example, the management process indicates that the aggregated data may have an error level of 5%. Consequently, a similarity level of 0.95 (or other level derived from the acceptable error level of the aggregated data, may be derived using any relationship) may be treated as high enough to warrant grouping. Accordingly, three groups may be established based on the similarity graph with one group including first and second data collectors 410, 412, and the other two groups including the other respective data collectors 414, 416.

Based on the three groups, it is determined that a model training capacity of 3 models is necessary for a model training device. Turning to FIG. 4C, because only model training device 430 is available, model training device 430 is selected and an upgrade for the model training device 430 is scheduled. When the upgrade is performed, technician 470 installs processor 472 thereby increasing the available computing resources of model training device 430. By doing so, the model training capacity of the updated model training device, as seen in FIG. 4D, is increase to three inference models.

After updated model training device 430 is obtained, updated model training device 430 trains three twin inference models for the data collectors and data aggregator 420. Copies of all of the twin inference models are provided to data aggregator 420. A first twin inference model (trained using training data from these two data collectors) may be provided to first data collector 410 and second data collector 412. A second twin inference model (trained using training data from this data collectors) may be provided to third data collector 414. A third twin inference model (trained using training data from this data collectors) may be provided to fourth data collector 416.

Turning to FIG. 4E, once the twin inference models are distributed, the data collectors and data aggregator 420 may begin to aggregate data using the twin inference models by transmitting inference based data to data aggregator 420. The inference based data may (i) not include any data when inference for collected data closely match the collected data, (ii) reduced size representations when there is a large enough delta between the inferences and the collected data, and/or (iii) copies of collected data when there are larger differences between the inferences and the collected data.

As illustrated in FIGS. 4A-4E, by implementing systems in accordance with embodiments disclosed herein the likelihood of decreasing resource expenditures for timely data aggregation may be improved through proactive system planning and operation.

Any of the components illustrated in FIGS. 1-4E may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include 10 devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data collection in a distributed environment where data is aggregated in a data aggregator of the distributed environment and the data is collected from data collectors operably connected to the data aggregator via a communication system, comprising:
obtaining an error limit for the data aggregated in the data aggregator;
obtaining a similarity graph for the data collectors;
identifying, using the similarity graph, a quantity of computing resources to train a quantity of twin inference models, the quantity of twin inference models being based on the error limit;
obtaining a model training device based on the quantity of computing resources;
initiating aggregation of the data collected by the data collectors using the model training device;
obtaining the data aggregated in the data aggregator using the quantity of the twin inference models trained by the model training device.

2. The method of claim 1, wherein initiating aggregation of the data collected by the data collectors using the model training device comprises:
training the quantity of the twin inference models based on the error limit; and
deploying the quantity of the twin inference models based on groupings of the data collectors based on the similarity graph.

3. The method of claim 2, wherein identifying the quantity of computing resources comprises:
identifying an edge value threshold based on the error limit for the data;
grouping nodes of the similarity graph into groupings based on the edge value threshold; and
calculating the quantity of computing resources based on a cardinality of the groupings and a per twin inference model computing resources training cost.

4. The method of claim 3, wherein the similarity graph comprises:
nodes, each node of the nodes corresponding to one of the data collectors; and
edges, each of the edges associating a pair of nodes, the respective edge indicating a similarity of data collected by the associated pair of the nodes.

5. The method of claim 2, wherein the data collectors that are members of each grouping receive a same twin inference model of the quantity of the twin inference models, and data collectors that are members of different groups of the groups receive different twin inference models of the quantity of the twin inference models.

6. The method of claim 5, wherein obtaining the data aggregated in the data aggregator comprises:
obtaining, from a first data collector of the data collectors that is a member of a group of the groupings, first reduced size data based on a portion of data collected by the first data collector;
obtaining, from a second data collector of the data collectors that is a member of the group of the groupings, second reduced size data based on a portion of data collected by the first data collector;
reconstructing the portion of the data collected by the first data collector using a first inference obtained from a first twin inference model of the quantity of twin inference models; and
reconstructing the portion of the data collected by the second data collector using a second inference obtained from the first twin inference model of the quantity of twin inference models.

7. The method of claim 6, wherein obtaining the data aggregated in the data aggregator further comprises:
obtaining, from a third data collector of the data collectors that is a member of a second group of the groupings, third reduced size data based on a portion of data collected by the third data collector; and
reconstructing the portion of the data collected by the third data collector using a third inference obtained from a second twin inference model of the quantity of twin inference models.

8. The method of claim 7, wherein the reconstructed portion of the data collected by the first data collector comprises a quantity of error that is within the error limit.

9. The method of claim 1, wherein the model training device is obtained by selecting the model training device from a plurality of model training device, the selected model training device having access to a quantity of computing resources that exceeds the identified quantity of computing resources.

10. The method of claim 1, wherein the model training device is obtained by allocating computing resources to the model training device until the model training device has access to a quantity of computing resources that exceeds the identified quantity of computing resources.

11. The method of claim 1, wherein the model training device is obtained by transferring workloads hosted by the model training device to other devices until a quantity of free computing resources of the model training device exceeds the identified quantity of computing resources.

12. The method of claim 1, wherein obtaining a model training device based on the quantity of computing resources comprises:
increasing the error limit;
identifying, using the similarity graph, a second quantity of computing resources to train a second quantity of twin inference models, the second quantity of twin inference models being based on the increased error limit; and
obtaining a model training device based on the second quantity of computing resources.

13. A non-transitory machine-readable medium having instructions stored therein, which when executed by a processor, cause the processor to perform operations for managing data collection in a distributed environment where data is aggregated in a data aggregator of the distributed environment and the data is collected from data collectors operably connected to the data aggregator via a communication system, the operations comprising:
obtaining an error limit for the data aggregated in the data aggregator;
obtaining a similarity graph for the data collectors;
identifying, using the similarity graph, a quantity of computing resources to train a quantity of twin inference models, the quantity of twin inference models being based on the error limit;
obtaining a model training device based on the quantity of computing resources;
initiating aggregation of the data collected by the data collectors using the model training device;
obtaining the data aggregated in the data aggregator using the quantity of the twin inference models trained by the model training device.

14. The non-transitory machine-readable medium of claim 13, wherein initiating aggregation of the data collected by the data collectors using the model training device comprises:
training the quantity of the twin inference models based on the error limit; and
deploying the quantity of the twin inference models based on groupings of the data collectors based on the similarity graph.

15. The non-transitory machine-readable medium of claim 14, wherein identifying the quantity of computing resources comprises:
identifying an edge value threshold based on the error limit for the data;
grouping nodes of the similarity graph into groupings based on the edge value threshold; and
calculating the quantity of computing resources based on a cardinality of the groupings and a per twin inference model computing resources training cost.

16. The non-transitory machine-readable medium of claim 15, wherein the similarity graph comprises:
nodes, each node of the nodes corresponding to one of the data collectors; and
edges, each of the edges associating a pair of nodes, the respective edge indicating a similarity of data collected by the associated pair of the nodes.

17. A data processing system, comprising:
a processor; and
a memory coupled to the processor to store instructions, which when executed by the processor, cause the processor to perform operations for managing data collection in a distributed environment where data is aggregated in a data aggregator of the distributed environment and the data is collected from data collectors operably connected to the data aggregator via a communication system, the operations comprising:
obtaining an error limit for the data aggregated in the data aggregator;
obtaining a similarity graph for the data collectors;
identifying, using the similarity graph, a quantity of computing resources to train a quantity of twin inference models, the quantity of twin inference models being based on the error limit;
obtaining a model training device based on the quantity of computing resources;
initiating aggregation of the data collected by the data collectors using the model training device;
obtaining the data aggregated in the data aggregator using the quantity of the twin inference models trained by the model training device.

18. The data processing system of claim 17, wherein initiating aggregation of the data collected by the data collectors using the model training device comprises:
training the quantity of the twin inference models based on the error limit; and
deploying the quantity of the twin inference models based on groupings of the data collectors based on the similarity graph.

19. The data processing system of claim 18, wherein identifying the quantity of computing resources comprises:
identifying an edge value threshold based on the error limit for the data;
grouping nodes of the similarity graph into groupings based on the edge value threshold; and
calculating the quantity of computing resources based on a cardinality of the groupings and a per twin inference model computing resources training cost.

20. The data processing system of claim 19, wherein the similarity graph comprises:
nodes, each node of the nodes corresponding to one of the data collectors; and
edges, each of the edges associating a pair of nodes, the respective edge indicating a similarity of data collected by the associated pair of the nodes.
